(19) United States
(12) Patent Application Publication
(10) Pub. No.: US 2024/0349040 A1
(43) Pub. Date: Oct. 17, 2024

(54) PHYSICAL (PHY) LAYER SECURITY MODES

(71) Applicant: QUALCOMM Incorporated, San Diego, CA (US)

(72) Inventors: Ahmed ELSHAFIE, San Diego, CA (US); Hung Dinh LY, San Diego, CA (US); Alexandros MANOLAKOS, Athens (GR)

(21) Appl. No.: 18/292,054

(22) PCT Filed: Aug. 17, 2022
(86) PCT No.: PCT/US2022/075068

§ 371 Date: Jan. 25, 2024

(30) Foreign Application Priority Data
Sep. 29, 2021 (GR) 20210100644

(51) Int. Cl. H04W 12/03

(52) U.S. Cl. CPC H04W 12/03

(57) ABSTRACT

Certain aspects of the present disclosure provide techniques for securing physical (PHY) layer communications. Certain aspects relate to a method for wireless communication by a user equipment (UE). In some examples, the method includes receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the method includes communicating over the PHY channel in accordance with the mode.

### CROSS-REFERENCE TO RELATED APPLICATION(S)

This application claims priority to Greece application No. 20210100644 filed Sep. 29, 2021, which is assigned to the assignee hereof and incorporated by reference herein in its entirety.

### INTRODUCTION

Aspects of the present disclosure relate to wireless communications, and more particularly, to techniques for securing physical (PHY) layer communications.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, as the number of devices using wireless communication systems continues to increase, securing communications between devices becomes even more challenging. Consequently, there exists a need for further improvements in wireless communications systems to overcome various challenges.

### SUMMARY

Certain aspects relate to a method for wireless communication by a user equipment (UE). In some examples, the method includes receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the method includes communicating over the PHY channel in accordance with the mode.

Certain aspects relate to a method for wireless communication by a wireless communication device. In some examples, the method includes transmitting, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the method includes communicating, with the UE, over the PHY channel in accordance with the mode.

Certain aspects relate to a user equipment (UE) configured for wireless communication, wherein the UE includes a memory and a processor coupled to the memory. In some examples, the processor and the memory are configured to receive, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the processor and the memory are configured to communicate, with the wireless communication device, over the PHY channel in accordance with the mode.

Certain aspects relate to a wireless communication device comprising a memory and a processor coupled to the memory. In some examples, the processor and the memory are configured to transmit, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the processor and the memory are configured to communicate, with the UE, over the PHY channel in accordance with the mode.

Certain aspects relate to a user equipment (UE). In some examples, the UE includes means for receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the UE includes means for communicating over the PHY channel in accordance with the mode.

Certain aspects relate to a wireless communication device. In some examples, the wireless communication device includes means for transmitting, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the wireless communication device includes means for communicating, with the UE, over the PHY channel in accordance with the mode.

Certain aspects relate to a non-transitory computer-readable medium having instructions stored thereon that, when executed by a user equipment (UE), cause the UE to perform operations. In some examples, the operations include receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the operations include communicating, with the wireless communication device, over the PHY channel in accordance with the mode.

Certain aspects relate to a non-transitory computer-readable medium having instructions stored thereon that, when executed by a wireless communication device, cause the wireless communication device to perform operations. In some examples, the operations includes transmitting, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. In some examples, the operations includes communicating, with the UE, over the PHY channel in accordance with the mode.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a diagram conceptually illustrating a sidelink communication between a first user equipment (UE) and one or more second UEs.

FIG. 3 is a block diagram conceptually illustrating aspects of an example of a base station (BS) and UE.

FIGS. 4A-4D depict various example aspects of data structures for a wireless communication network.

FIG. 5 is a call-flow diagram illustrating example communications between a wireless communication device and a UE.

FIG. 6 is a call-flow diagram illustrating example communications between a BS and a first UE, and sidelink communications between the first UE and a second UE.

FIG. 7 is a flow diagram illustrating example operations for wireless communication, in accordance with certain aspects of the present disclosure.

FIG. 8 is a flow diagram illustrating example operations for wireless communication, in accordance with certain aspects of the present disclosure.

FIG. 9 is a block diagram illustrating aspects of an example communications device.

FIG. 10 is a block diagram illustrating aspects of an example communications device.

### DETAILED DESCRIPTION

Aspects of the present disclosure provide apparatuses, methods, processing systems, and computer-readable mediums for securing physical (PHY) layer communications.

As described in more detail below, a wireless communication device (e.g., a base station (BS), a user equipment (UE), and/or the like) can wirelessly communicate (e.g., communicate on a downlink, uplink, and/or sidelink) with one or more user equipments (UEs). Though certain aspects are discussed with respect to a BS as a wireless communication device communicating with a UE (e.g., on a downlink or uplink), it should be noted that such aspects may similarly apply to other wireless communication scenarios, such as a UE as a wireless communication device communicating with another UE (e.g., on a sidelink). In an example where multiple UEs are communicating with the same wireless communication device, the wireless communication device may use multiple-user multiple-input multiple-output (MU-MIMO) to maintain communication with the UEs.

Some devices may be capable of eavesdropping on wireless communications between a wireless communication device and a UE. For example, a device, such as an eavesdropping UE, may receive transmissions from the wireless communication device and/or transmissions from another UE despite the eavesdropping UE not being part of the communication. If the PHY layer of the communications is not secure, the eavesdropping UE may be capable of decoding the communications, such as if no upper layer (e.g., application layer) security is used for the communications.

Thus, aspects of the disclosure are directed to multiple PHY layer security modes configured to prevent other devices from decoding data that is not intended for them. In some examples, the PHY layer security modes may include multiple security techniques that may be applied to one or more types of signals. For example, techniques of a security mode may include rotation and/or remapping of a modulation constellation associated with a transmitted signal. In another example, techniques of a security mode may include adding or inserting “artificial noise” into a transmitted signal. That is, a transmitting device (e.g., UE and/or BS) may deliberately add an additional noise signal to a transmission, wherein that noise signal is meant to obscure legitimate aspects (e.g., reference signal, payload, etc.) of the transmission.

Aspects of the disclosure are also directed to particular types of signals that the security mode techniques may be applied to. In some examples, the security mode techniques may be applied to an uplink/downlink/sidelink physical channel (e.g., a control channel, a data channel, broadcast channel, feedback channel, etc.). In some examples, the security mode techniques may be also, or alternatively, be applied to a reference signal of a transmission.

As described in more detail below, a wireless communication device may configure a UE with a secret key that allows the UE to determine which PHY layer security mode (e.g., which one or more techniques, and which one or more types of signals) will be used in communications between the wireless communication device and the UE, or between the UE and another wireless communication device. The secret key may also provide the UE and the wireless communication device or the other wireless communication device with a means for securely encoding and correctly decoding communications between the two devices. In certain aspects, the UE may configure another UE with a secret key to secure sidelink communications between the two UEs.

To prevent other devices from understanding the secret key used by one or more UEs and/or a BS in a legitimate communication, the UE/BS may encode the secret key prior to communicating the secret key to the intended UE. Such an encoding may prevent other devices from determining not only the channel used by a UE or a BS, but, in some aspects, also which UE in a MU-MIMO environment is communicating which signals.

### Introduction to Wireless Communication Networks

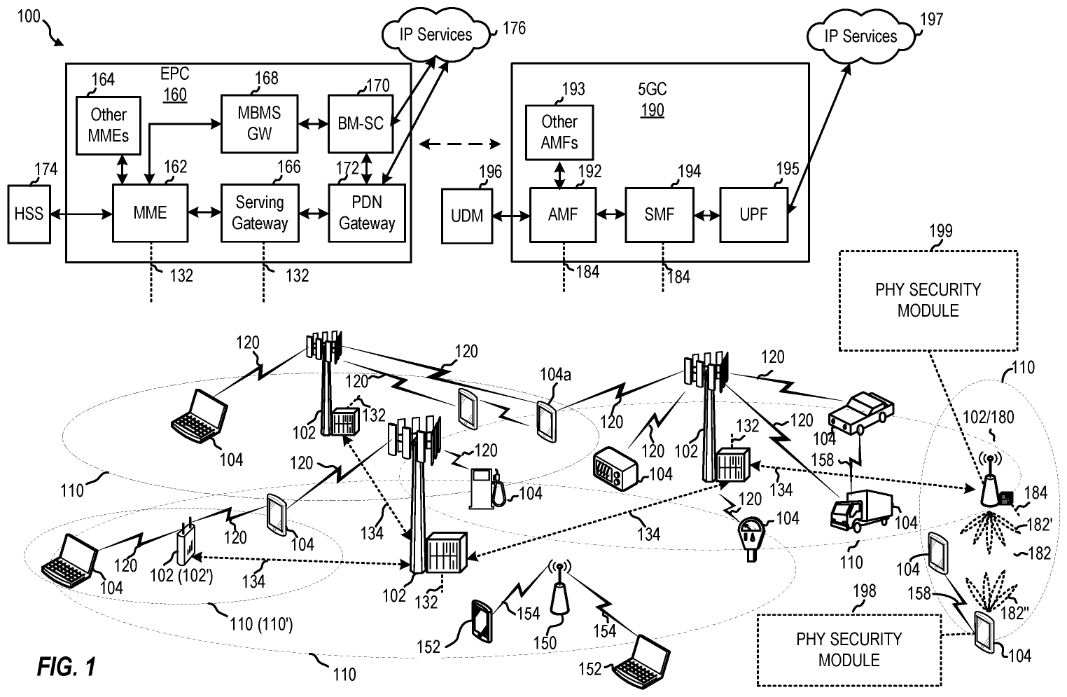

FIG. 1 is a schematic illustration of an example wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as MU-MIMO. This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, transmit and receive directions for base station 180 may or may not be the same. Similarly, transmit and receive directions for UE 104 may or may not be the same.

Base station 180 includes a PHY Security module 199, which may be configured to secure PHY layer communications. UE 104 includes PHY Security module 198, which may be used configured to secure PHY layer communications.

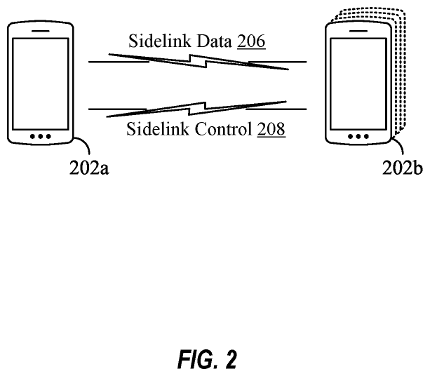

FIG. 2 is a diagram conceptually illustrating a sidelink communication between a first UE 202a and one or more second UEs 202b (collectively, “second UE 202b”). In various examples, any one of the first UE 202a and the second UE 202b may correspond to any UE 104 in the example wireless communication system 100 of FIG. 1.

The first UE 202a and the second UE 202b may utilize sidelink signals for direct D2D communication. Sidelink signals may include sidelink data 206 (i.e., sidelink traffic) and sidelink control information 208. Broadly, the first UE 202a and one or more a second UEs 202b may communicate sidelink data 206 and sidelink control information 208 using one or more data channels and control channels. In some aspects, data channels include a physical sidelink shared channel (PSSCH) and/or sidelink shared channel (SL-SCH). In some aspects, control channels include a physical sidelink control channel (PSCCH) and/or physical sidelink feedback channel (PSFCH).

Sidelink control information 208 may include a source transmit signal (STS), a direction selection signal (DSS), and a destination receive signal (DRS). The DSS/STS may provide for a UE 202 (e.g., 202a, 202b) to request a duration of time to keep a sidelink channel available for a sidelink signal; and the DRS may provide for the UE 202 to indicate the availability of the sidelink channel, e.g., for a requested duration of time. Accordingly, the first UE 202a and the second UE 202b may negotiate the availability and use of sidelink channel resources prior to communication of sidelink data 206 information.

In some configurations, any one or more of the first UE 202a or the second UE 202b may be responsible for initiating and/or scheduling traffic in a D2D communication, including the communication of sidelink data 206 and sidelink control information 208, and maintenance of the sidelink communication channel(s). For example, the first UE 202a may be responsible for scheduling and/or initiating beam management procedures (e.g., initial beam selection procedures, beam sweeping procedures, beam refinement procedures, etc.) between the first UE 202a and the second UE 202b, as disclosed herein. In this example, the second UE 202b receives scheduling control information, including but not limited to beam management scheduling information, synchronization or timing information, or other control information.

The channels or carriers illustrated in FIG. 2 are not necessarily all of the channels or carriers that may be utilized between a first UE 202a and a second UE 202b in a sidelink communication, and those of ordinary skill in the art will recognize that other channels or carriers may be utilized in addition to those illustrated, such as other data, control, and feedback channels.

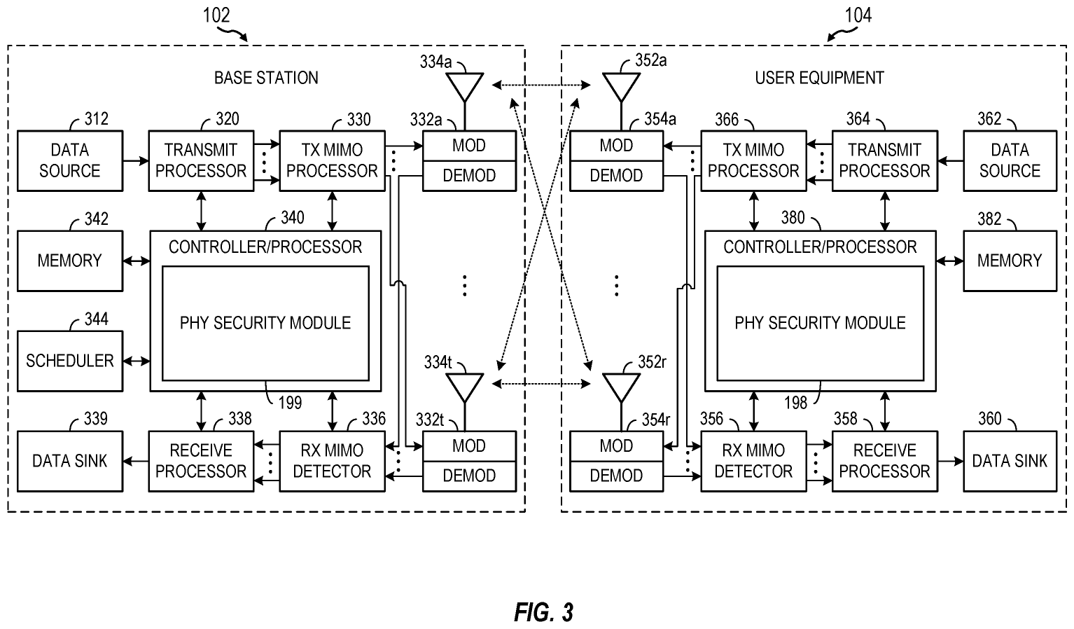

FIG. 3 is a block diagram illustrating aspects of an example base station (BS) 102 and a user equipment (UE) 104.

Generally, base station 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, base station 102 may send and receive data between itself and user equipment 104.

Base station 102 includes controller/processor 340, which may be configured to implement various functions related to wireless communications. In the depicted example, controller/processor 340 includes PHY security module 199. Notably, while depicted as an aspect of controller/processor 340, PHY security module 199 may be implemented additionally or alternatively in various other aspects of base station 102 in other implementations.

Generally, user equipment 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., data source 362) and wireless reception of data (e.g., data sink 360).

User equipment 104 includes controller/processor 380, which may be configured to implement various functions related to wireless communications. In the depicted example, controller/processor 380 includes PHY Security module 198. Notably, while depicted as an aspect of controller/processor 380, PHY Security module 198 may be implemented additionally or alternatively in various other aspects of user equipment 104 in other implementations.

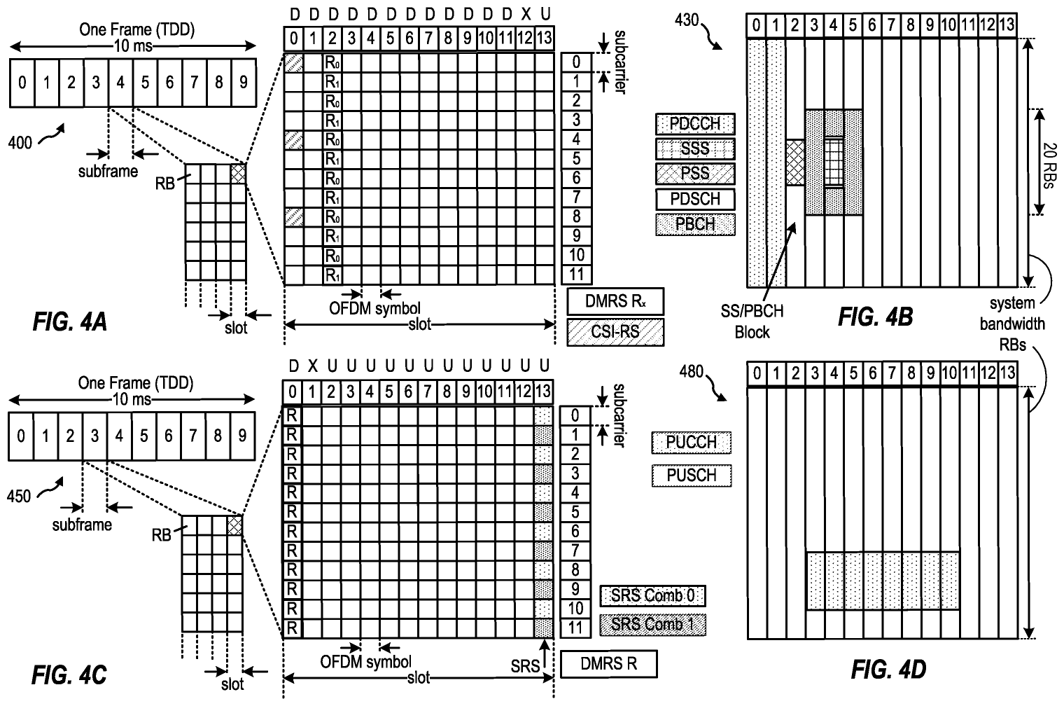

FIGS. 4A-4D are block diagrams conceptually illustrating aspects of data structures for a wireless communication network, such as wireless communication network 100 of FIG. 1. In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Further discussions regarding FIG. 1, FIG. 3, and FIGS. 4A-4D are provided later in this disclosure.

### Aspects Related to Physical (PHY) Layer Security

As illustrated in FIG. 1, a single BS 102 can wirelessly communicate with multiple UEs 104. However, another UE 104a may be able to eavesdrop on wireless communications (e.g., downlink and uplink communications) between UEs 104 and the BS 102. One or more PHY layer security modes may prevent devices from decoding data that is not intended for them in such a scenario or other suitable scenarios, such as sidelink communication between UEs 104.

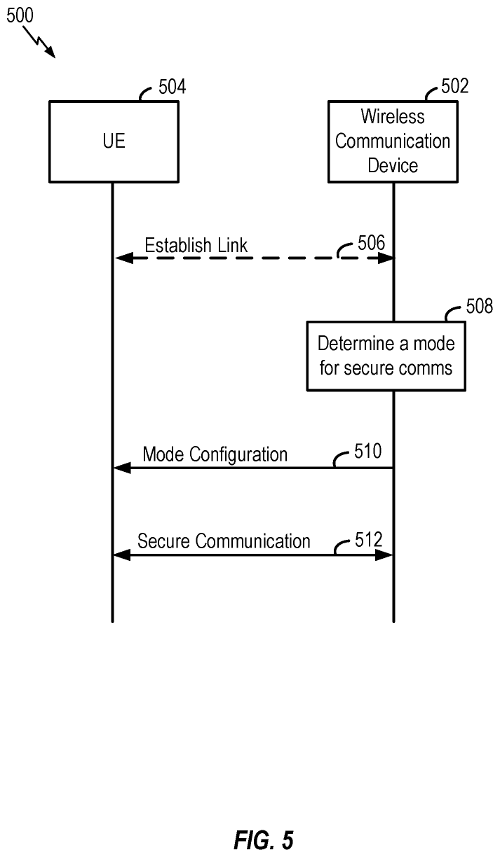

FIG. 5 is a call-flow diagram illustrating example communications 500 between a wireless communication device 502 (e.g., a base station (BS) 102 of FIGS. 1 and 3, a user equipment (UE) 104 of FIGS. 1 and 3, and/or the like) and a UE 504 (e.g., another UE 104 of FIGS. 1 and 3).

Initially, the UE 504 and the wireless communication device 502 may establish a communication link 506 for wireless communication. The wireless communication may include physical (PHY) layer aspects, such as physical channels (e.g., physical downlink shared channel (PDSCH), physical broadcast channel (PBCH), physical downlink control channel (PDCCH), physical uplink shared channel (PUSCH), physical uplink control channel (PUCCH), physical random-access channel (PRACH), physical sidelink shared channel (PSSCH), physical sidelink control channel (PSCCH), physical sidelink broadcast channel (PSBCH) etc.).

As illustrated, the communication link 506 is established prior to a first process 508, wherein the wireless communication device 502 determines a mode for secure communications. However, it should be noted that in some implementations, the first process 508 may occur during or before establishment of the communication link 506. In such an example, the wireless communication device 502 may provide mode configuration information (e.g., information in a first transmission 510) while establishing the communication link 506.

At a first process 508, the wireless communication device 502 may determine a mode for secure communication between the UE 504 and the wireless communication device 502. The mode for secure communication may be one of a plurality of PHY layer security modes for preventing an eavesdropping device from identifying and/decoding PHY channel communications between devices.

In some examples, each of the plurality of security modes is associated with one or more of: (i) at least one type of signal to secure using one or more secret keys, or (ii) at least one technique to secure communications using the one or more secret keys. In certain aspects, the type of signal may correspond to any suitable physical channel (e.g., control channels, data channels, broadcast channels, etc.), including uplink channels, downlink channels, and/or sidelink channels (e.g., PSCCH, PSSCH, PSFCH, etc.). In certain aspects, the type of signal may also correspond to a reference signal (e.g., demodulation reference signal (DM-RS), phase tracking reference signal (PTRS), sounding reference signal (SRS), channel state information reference signal (CSI-RS), etc.) used in an uplink/downlink/sidelink transmission. The type of signal may also correspond to a particular type of message (e.g., downlink control information (DCI) message, uplink control information (UCI) message, and any other suitable types of message carried in a physical channel). The technique to secure communications may include one or more of a modified modulation scheme (e.g., quadrature amplitude modulation (QAM), quadrature phase-shift keying (QPSK), etc.), or use of artificial noise in a transmission.

Multiple techniques for modifying a modulation scheme are contemplated by this disclosure. For example, a first technique may include a rotation of modulation constellation points (e.g., quadrature amplitude modulation (QAM) constellation points, physical shift key (PSK) constellation points, quadrature PSK (QPSK) constellation points, etc.) based on a secret key. In one example, the wireless communication device 502 may apply a certain rotation angle in the complex plane of a conventional QAM constellation (e.g., 4-QAM constellation, 16-QAM constellation, 256-QAM constellation, etc.). The secret key may include the angle of rotation, which can be provided to a receiver (e.g., the UE 504) prior to transmitting a signal using a rotated QAM constellation. After providing the UE 504 with the secret key, the wireless communication device 502 may transmit signaling to the UE 504 according to the rotated QAM constellation (e.g., transmitting in different carriers and/or different time slots relative to the conventional constellation). The UE 504 may receive the transmission, then use the rotation angle to determine each bit associated with a received point from the transmission.

Another example technique for modifying a modulation scheme may include remapping modulation constellation points based on a secret key. In this example, a wireless communication device 502 may generate a new constellation wherein a point-to-bit mapping of the new constellation is different from that of a conventional constellation. The secret key may include a remapping table for translating each point in a constellation to a remapped bit. In another example, the secret key may include an equation or operation for determining a remapped bit associated with each bit in a (e.g., QAM) constellation. In another example, the secret key may include any suitable indication of a bit sequence mapped onto different signal points of the QAM constellation. Accordingly, the UE 504 may receive a signal transmitted by the wireless communication device 502, then proceed to remap received points of the signal to bits according to the new constellation in order to correctly decode the transmission.

As discussed, another technique for securing communications may include the use of artificial noise in a transmission. In some examples, the wireless communication device 502 may generate an “artificial noise” signal (also referred to as a “noise signal” herein), then add the noise signal to a legitimate downlink transmission to obscure the legitimate aspects of the downlink transmission. As such, the added noise signal may prevent another device that is not an intended receiver from correctly decoding the legitimate downlink transmission. The wireless communication device 502 may generate the noise signal using any suitable algorithm or technique. The noise signal may include a randomized signal, an additive white Gaussian noise (AWGN) signal, or any other suitable noise signal that can be filtered/canceled from a transmission by a receiving device (e.g., UE 504).

The wireless communication device 502 may also generate a secret key corresponding to the artificial noise, and transmit the secret key to an intended UE (e.g., UE 504). In some examples, the secret key may provide the UE 504 with an index configured to identify a particular noise signal known to both the UE 504 and the wireless communication device 502 (e.g., one or more noise signals preconfigured at the UE 504 and wireless communication device 502). In other examples, the wireless communication device 502 may randomly generate the artificial noise signal and also generate a secret key corresponding to the generated the artificial noise signal. In this example, neither the UE 504 nor the wireless communication device 502 are preconfigured with the noise signal, so the secret key may be configured to allow the UE 504 to determine a noise pattern associated with the signal. In either example, the UE 504 may use the secret key to filter the artificial noise signal from a subsequent transmission from the wireless communication device 502.

A security mode (e.g., modified modulation scheme and/or an artificial noise in a transmission) may be used on one or more resources (e.g., time-frequency resources, such as resource elements (REs), antenna ports, and/or the like) associated with the transmission. For example, each transmission from the wireless communication device 502 may be transmitted from a specific antenna port, the identity of which may be known (e.g., by reference signal and/or other identifier provided in a first transmission 510 discussed below) by the UE 504. In one example, the wireless communication device 502 or UE 504 may apply a particular modulation scheme and/or a particular artificial noise to a single resource (e.g., an RE, a particular antenna port, etc.), a group of resources (e.g., a resource block (RB), a (pre-) configured grouping of resources, random grouping resources, etc.), all the resources of the transmission (e.g., all the REs of the transmission), or on a time basis (e.g., one or more particular symbols), in accordance with the security mode. Thus, in some examples, a security mode may be applied to less than all of the resources of a transmission, leaving one or more resources unaffected by a security mode.

In another example, a first security mode may be applied to one or more resources of a transmission (e.g., a first RE or a first group of REs), while a second security mode is applied to one or more remaining resources (e.g., a second RE or a second group of REs) of the same transmission. That is, a wireless communication device 502 or UE 504 may apply multiple security modes to a single transmission. For example, the wireless communication device 502 may apply a first security mode (e.g., QAM constellation rotation of a DM-RS) to one or more REs occupied by the DM-RS, while also applying a second security mode (e.g., artificial noise added to a PDCCH of the same transmission carrying the DM-RS) to one or more REs of the PDCCH. In another example, the wireless communication device 502 may apply a first security mode (e.g., a first QAM constellation rotation of a DM-RS) to a first RE used by the DM-RS, while also applying a second security mode (e.g., a second QAM constellation rotation of a DM-RS) to a second RE used by the DM-RS.

It should be noted that each security mode of the plurality of security modes may be used for one or more types of signals. For example, the wireless communication device 502 may determine that a first security mode may correspond to (e.g., may be used for) a DM-RS, a second security mode may correspond to a control channel and/or a data channel, and a third security mode, may correspond to both another DM-RS and a control channel and/or data channel. In another example, a modified QAM of the DM-RS may correspond to (e.g., may be used for) the first security mode, use of artificial noise in the control channel and/or a data channel may correspond to the second security mode, and a modified QAM of the control channel and/or data channel, and use of artificial noise in the DM-RS may correspond to the third security mode.

In some examples, the plurality of security modes may include one or more of a mode 1, mode 2, mode 3 and mode 4, as well as submode 1 and submode 2. Mode 1 may be directed to a secure DM-RS signal included in a transmission to prevent an eavesdropping device from properly decoding the transmission.

Submode 1 may be directed to a QAM rotation or remapping of QAM constellation points based on a secret key. As discussed, the same secret key and/or QAM rotation may be used for a group of REs (e.g., less than all REs in a transmission), all REs of the transmission, or a different secret key and/or QAM rotation may be used for each RE in the transmission.

Submode 2 may be directed to an artificial noise that, in some examples, is generated based on a secret key. As discussed, the same artificial noise may be used for a group of REs (e.g., less than all REs in a transmission), all REs of the transmission, or a different artificial noise may be used for each RE in the transmission. Mode 1 may be used to secure a particular transmission with or without one or more of submode 1 and submode 2 on the same transmission.

Mode 2 may be directed to a securing a physical transmission (e.g., PSSCH, PDSCH, PUSCH, PSCCH, PDCCH, and/or PUCCH) using one or more of submode 1 or submode 2.

Mode 3 may be directed to securing both the DM-RS (e.g., mode 1) and the physical transmission over which the DM-RS is transmitted, via one or more of submode 1 or submode 2.

Mode 4 may be directed to a mode of transmitting signaling without the security of any of modes 1-3 or submodes 1 and 2 applied to the transmission.

In some examples, one or more of the modes and submodes may only be applied to transmissions having a particular format. For example, mode 2 may be applied to a particular PUCCH format (e.g., format 1). In some examples, the device 502 selects a mode based on a quality of service configured at the device 502. For example, if the quality of service indicates that a secure DMRS is required, but a secure PSSCH, PDSCH, PUSCH, PSCCH, PDCCH, and/or PUCCH is not needed, the device 502 may use mode 1. As another example, if the quality of service indicates that a secure DMRS is not required, but a secure PSSCH, PDSCH, PUSCH, PSCCH, PDCCH, and/or PUCCH is required, the device 502 may use mode 2. As another example, if the quality of service indicates that a secure DMRS is required, and a secure PSSCH, PDSCH, PUSCH, PSCCH, PDCCH, and/or PUCCH is required, the device 502 may use mode 3. The use of the submodes may also be based on quality of service requirements.

At the first process 508, the wireless communication device 502 may also determine one or more of the plurality of security modes that correspond (e.g., are used for) a particular quality of service (QOS). For example, ultra-reliable low-latency communications (URLLC) may be associated with a relatively high security mode, while enhanced mobile broadband (eMBB) may be associated with a lower security mode. In some examples, a high security mode may include multiple security techniques used for the same communication (e.g., both modulation constellation rotation and artificial noise for a single PDSCH transmission, and/or multiple secret keys), whereas a lower security mode may include only one security technique for the same transmission.

More specifically, one or more of the modes and submodes may be applied to a transmission according to QoS requirements corresponding to the transmission and/or to an underlying application that generated the transmission. For example, each mode/submode, and/or combination of modes/submodes, may correspond to different levels of security that are applied to a transmission according to QoS requirements associated with the transmission and/or a channel over which the transmission is communicated. Each of the different levels of security may also have a corresponding number of secret keys associated with it, as well as an indication of which REs in a transmission that a given mode/submode, and/or secret key will be applied to. For example, a higher level of security may use multiple secret keys on a single transmission (e.g., few common secret keys or no common secret keys between REs of a transmission), while a relatively lower level of security may use a single secret key. The UE 504 may be configured with the corresponding relationship between one or more modes/submodes and a security level by a network (e.g., wireless communication device 502 or a BS) during a RACH procedure or link establishment. In other examples, the UE 504 may be configured with the corresponding relationship during manufacture, according to a wireless communication standard.

In a first transmission 510, the wireless communication device 502 may configure the UE 504 with one or more security modes that the UE 504 can use for encoding uplink transmissions to the wireless communication device 502, and for decoding downlink transmissions from the wireless communication device 502. For example, the first transmission 510 may be configured to indicate one or more security modes (e.g., rotation and/or remapping of modulation constellation, and/or artificial noise) and one or more types of signals corresponding to each security mode. The first transmission 510 may also indicate specific resources (e.g., particular REs, particular RBs, and/or a particular antenna port, etc.) that a corresponding security mode will be applied to in an uplink/downlink/sidelink transmission. In some examples, when wireless communication device 502 is a base station (e.g., base station 102), wireless communication device 502 may transmit the first transmission 510 using Uu RRC/MAC-CE or DCI. On the other hand, when wireless communication device 502 is a UE (e.g., UE 104), wireless communication device 502 may transmit the first transmission 510 using PC5 RRC-CE or SCI (e.g., SCI-1 or SCI-2). The first transmission 510 may also provide secret keys relating to the indicated security modes. For example, the wireless communication device 502 may provide the UE 504 with a secret key indicating a rotation angle and/or an identification of a particular constellation to be rotated for a security mode that includes a rotated modulation constellation. Similarly, for a security mode that includes a remapped constellation, a corresponding secret key may include a remapping table for translating each point in a known constellation to a remapped bit, an index corresponding to a (pre-) configured remapped constellation, and/or an equation or operation for determining a remapped bit associated with the known constellation. If the security mode includes artificial noise, a corresponding secret key may provide an indication of a noise pattern, such as an index corresponding to a (pre-) configured noise pattern. Thus, the first transmission 510 may provide a plurality of secret keys for one or more security modes, wherein different secret keys are used for different types of signals or different time-domain and/or frequency-domain resources.

The first transmission 510 may also include configuration information corresponding to one or more security modes. For example, the configuration information may include one or more rotated constellations and corresponding indices, one or more remapped constellations and corresponding indices, and/or one or more artificial noise patterns and corresponding indices.

In some examples, the configuration information includes an indication of one or more time-domain resources (e.g., symbol, slot, etc.), frequency-domain resources (e.g., tones, subchannels, carriers, subcarriers), and/or time-domain and frequency-domain resources (e.g., RE, RB, precoder resource group (PRG), resource block group (RBG), etc.) that each security mode can be applied to. For example, the indication of resources may include a bitmap, a defined pattern of time and/or frequency resources, or any other suitable indication of time-domain and/or frequency-domain resources corresponding to the security mode. A bitmap may include one or more values, wherein each value of the bitmap corresponds to a particular resource and indicates whether to use a security mode for communication over that resource. The same bitmap may be used for a single transmission instance or for multiple transmissions. For example, a first bitmap may provide an indication of which time-domain, frequency-domain, and/or time-domain and frequency-domain resources a security mode should be applied to in a UCI or a PUSCH. Accordingly, the UE 504 may use the same bitmap for each UCI or PUSCH it transmits to the wireless communication device 502.

In some examples, the configuration information includes a time domain resource allocation (TDRA) table having a plurality of entries, wherein each entry of the plurality of entries corresponds to one or more (e.g., unique) bitmaps. In this example, once the wireless communication device 502 has configured the UE 504 with the TDRA table and one or more bitmaps in the first transmission 510, the wireless communication device 502 can dynamically change which bitmap will be used for future communications by transmitting an indication of a TDRA table entry that corresponds to the bitmap to the UE 504. The indication of a TDRA table entry may be communicated from the wireless communication device 502 to the UE 504 using any suitable method of communication, including via a DCI message. In some examples, a TDRA table entry may correspond to multiple bitmaps. In such a case, the indication of a TDRA table entry may also include an index value or any other suitable value for identifying a particular one of the multiple bitmaps corresponding to the TDRA table entry.

In some examples, the configuration information may be encoded/encrypted prior to transmission to the UE 504 in the first transmission 510. For example, the wireless communication device 502 may encode/encrypt communications of one or more of bitmaps, secret keys, and/or other configuration information, to the UE 504. The wireless communication device 502 may first encode/encrypt the information using any suitable encoding/encryption technique. For example, the wireless communication device 502 may encode/encrypt the information using randomized asymmetric encryption operations and/or public-key cryptosystems such as Rivest-Shamir-Adleman (RSA), elliptic curve cryptography (ECC), channel reciprocity based key generation, and/or any other suitable encoding/encryption technique. In some examples, the encoding/encryption technique may include a logical operation (e.g., an exclusive OR (XOR) function, or another suitable logical operation). For example, each bitmap provided to the UE 504 from the wireless communication device 502 may be encoded/encrypted using one of the foregoing encoding/encryption methods.

In some examples, the configuration information may be encoded/encrypted using an advanced encryption standard (AES) cipher system prior to transmission of the configuration information. Generally, AES is a symmetric block cipher for encrypting and decrypting information. In some examples, the AES system may perform a series of one or more transformations on the configuration information and/or secret key prior to transmission of the information. In this example, the secret key may be used to transform the configuration information into an unintelligible form referred to as “cipher text.” The transformations may include one or more of: (1) adding a round key (e.g., a value derived from the cipher key) to the state (e.g., a two dimensional array of bytes representing the encoded/encrypted configuration information) using an XOR operation; (2) processing the state using a non-linear byte substitution table (S-Box); (3) cyclically shifting the last three rows of the state by different offsets; and/or (4) taking one or more of the columns of the state and mixing their data (e.g., independent of one another) to produce new columns.

In yet another example, the configuration information and/or secret key may be encoded/encrypted using any other cryptographic techniques (e.g., techniques that rely on XOR, block ciphering, bit-wise XOR, or combination thereof).

If the encoding/encryption technique includes a logical operation, the wireless communication device 502 may also provide the UE 504 with an argument value (e.g., a key for decoding the message) to reveal the encrypted data. Equation 1 below is one example of this using an XOR operation:

$$XOR ( p , {k}^{′} ) = k \qquad Equation 1$$

Where p is the argument value, k′ is the encrypted data, and k is the data unencrypted. In one example, the encrypted data may be an indication of the TDRA table entry and/or an index of a particular bitmap associated with that entry.

In some examples, the configuration information the first transmission 510 may include an indication of a security mode to use for communication, as well as a corresponding indication of a quality of service (QOS) associated with the security mode. In such an example, the wireless communication device 502 or the UE 504 may determine which of the plurality of security modes to use based on the QoS of a pending transmission. For example, the first transmission 510 may include an indication of a security mode, an indication of a QoS (e.g., URLLC), and an indication of one or more resources that the security mode should be used with. Thus, according to the mode configuration, the UE 504 may subsequently use the indicated security mode on the one or more resources of an uplink transmission having a URLLC QoS. This way, security of the URLLC uplink transmission is enhanced, and the intended recipient (e.g., the wireless communication device 502) is able to properly decode the uplink transmission. Similarly, if the wireless communication device 502 communicates a URLLC downlink transmission to the UE 504, then the UE 504 will be capable of properly decoding the downlink transmission according to the configuration information.

Once the UE 504 has been configured for secure communications, the UE 504 and the wireless communication device 502 may communicate 512 according to the foregoing security modes.

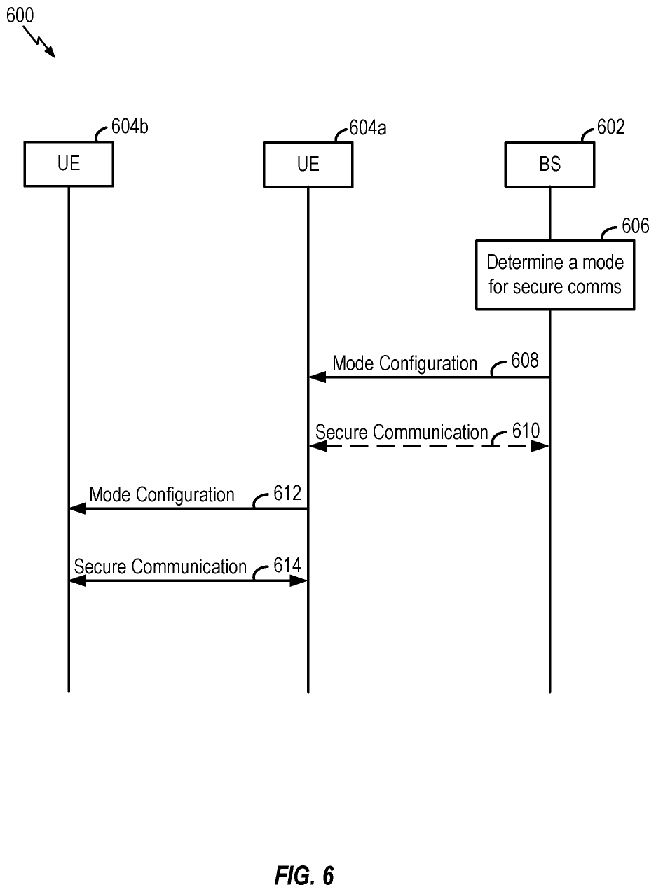

FIG. 6 is a call-flow diagram illustrating example communications 600 between a BS 602 (e.g., BS 102 of FIGS. 1 and 3, or wireless communication device of FIG. 5) and a first UE 604a (e.g., UE 104 of FIGS. 1 and 3, or wireless communication device of FIG. 5), and communications between the first UE 604a and a second UE 604b (e.g., another UE 104 of FIGS. 1 and 3). It should be noted that the foregoing aspects of FIG. 5 are applicable with equal thrust to the following description of FIG. 6.

During a first process 606, the BS 602 may determine one or more security modes for one or both of communications between the BS 602 and the first UE 604a, or sidelink communications between the first UE 604a and the second UE 604b. In some examples, certain security modes may be used for both sidelink and non-sidelink communications.

At a first transmission 608, the BS 602 may configure the first UE 604a with the determined one or more security modes by transmitting configuration information for the one or more security modes to the first UE 604a. In some examples, the configuration information may be used to secure communications between the first UE 604a and the BS 602 and/or sidelink communications between the first UE 604a and the second UE 604b. Accordingly, subsequent communications 610 between the first UE 604a and the BS 602 may optionally be secured based on the configuration information.

In a second transmission 612, the first UE 604a may configure the second UE 604b with the one or more security modes determined by the BS 602 by transmitting the configuration information to the second UE 604b. Accordingly, subsequent communications 614 between the first UE 604a and the second UE 604b may be secured according to the one or more security modes.

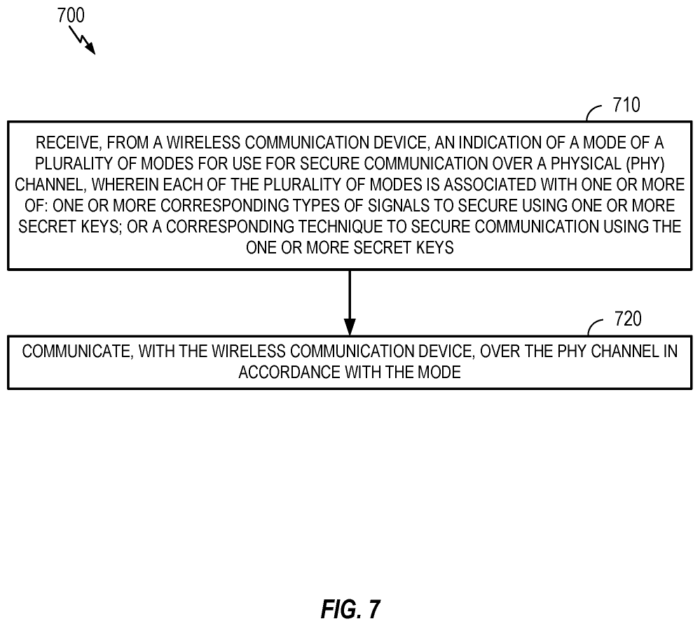

FIG. 7 is a flow diagram illustrating example operations 700 for wireless communication, in accordance with certain aspects of the present disclosure. The operations 700 may be performed, for example, by a UE (e.g., such as the UE 104 in the wireless communication network 100 of FIG. 1, the UE 504 or wireless communication device 502 of FIG. 5, or the first UE 604a or second UE 604b of FIG. 6). The operations 700 may be implemented as software components that are executed and run on one or more processors (e.g., controller/processor 380 of FIG. 3). Further, the transmission and reception of signals by the UE in operations 700 may be enabled, for example, by one or more antennas (e.g., antennas 352 of FIG. 3). In certain aspects, the transmission and/or reception of signals by the UE may be implemented via a bus interface of one or more processors (e.g., controller/processor 380) obtaining and/or outputting signals.

The operations 700 may begin, at a first block 710, by receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys.

The operations 700 may proceed to a second block 720, by communicating, with the wireless communication device, over the PHY channel in accordance with the mode.

In certain aspects, operations 700 may include receiving, from the wireless communication device, a second indication of one of the plurality of corresponding techniques, wherein communication over the PHY channel is further in accordance with the one of the plurality of corresponding techniques, and wherein the mode is associated with the one or more types of signals and a plurality of corresponding techniques to secure communication using the one or more secret keys.

In certain aspects, operations 700 may include receiving, from the wireless communication device, a message configuring the UE with the plurality of modes.

In certain aspects, operations 700 may include receiving, from the wireless communication device, a message indicating a first set of resources for secure communication, wherein communicating over the PHY channel in accordance with the mode comprises communicating over the PHY channel using the first set of resources.

In certain aspects, operations 700 may include receiving a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying first entry of the TDRA table associated with a first bitmap indicating the first set of resources.

In certain aspects, operations 700 may include receiving, from the wireless communication device, a key for decoding the message, wherein the message is encoded.

In certain aspects, each of the plurality of modes is associated with at least one technique of the one or more techniques, and the at least one technique comprises one or more of: use of noise based on the one or more secret keys; or use of modified quadrature amplitude modulation (QAM) points based on the one or more secret keys.

In certain aspects, each of the plurality of modes is associated with at least one type of signal of the one or more types of signals, and the one or more types of signals comprise one of: one or more demodulation reference signals; one or more control channels or data channels; or both the one or more demodulation reference signals and the one or more control channels or data channels.

In certain aspects, for a first mode of the plurality of modes, the one or more types of signals comprise one or more demodulation reference signals; for a second mode of the plurality of modes, the one or more types of signals comprise one or more control channels or data channels; and for a third mode of the plurality of modes, the one or more types of signals comprise both the one or more demodulation reference signals and the one or more control channels or data channels.

In certain aspects, the communicating comprises one or more of: transmitting on a sidelink channel; receiving on the sidelink channel; transmitting on an uplink channel; or receiving on a downlink channel.

In certain aspects, the first set of resources comprises one or more of: a first set of time and frequency resources; or a first set of antenna ports of the UE.

In certain aspects, the message comprises one or more bitmaps, wherein each value of the one or more bitmaps indicates whether to secure communication for a particular resource.

In certain aspects, the first entry of the TDRA table is further associated with a second bitmap indicating a second set of resources, and wherein the DCI message identifies the first bitmap of the first entry.

In certain aspects, the indication of the mode for secure communication comprises an indication of a quality of service (QOS), and wherein the method further comprises determining which of the plurality of modes for secure communication correspond to the QoS.

In certain aspects, the one or more secret keys comprise a plurality of secret keys, and wherein, for the mode, different secret keys are used for different types of signals or different one or more resources.

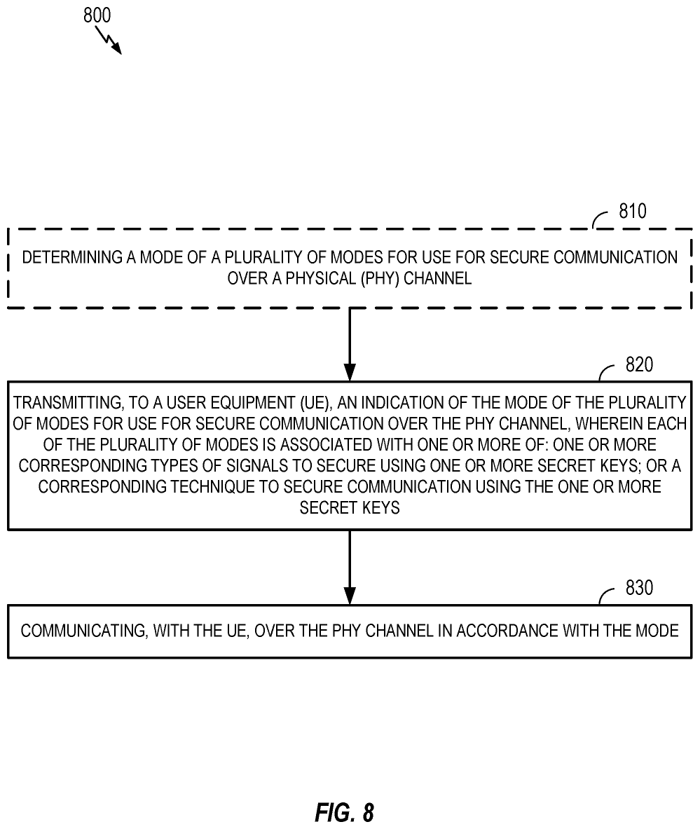

FIG. 8 is a flow diagram illustrating example operations 800 for wireless communication, in accordance with certain aspects of the present disclosure. The operations 800 may be performed, for example, by a wireless communication device (e.g., such as the BS 102 or UE 104 in the wireless communication network 100 of FIG. 1, the UE 504 or wireless communication device 502 of FIG. 5, or the BS 602, the first UE 604a, or second UE 604b of FIG. 6). The operations 800 may be complementary to the operations 700 of FIG. 7 performed by the UE. The operations 800 may be implemented as software components that are executed and run on one or more processors (e.g., controller/processor 340 and/or controller/processor 380 of FIG. 3). Further, the transmission and reception of signals by the wireless communication device in operations 800 may be enabled, for example, by one or more antennas (e.g., antennas 334 and/or antennas 352 of FIG. 3). In certain aspects, the transmission and/or reception of signals by the wireless communication device may be implemented via a bus interface of one or more processors (e.g., controller/processor 340 and/or controller/processor 380) obtaining and/or outputting signals.

Optionally, the operations 800 may begin, at a first block 810, by determining a mode of a plurality of modes for use for secure communication over a PHY channel.

The operations may include a second block 820 for transmitting, to a user equipment (UE), an indication of the mode of the plurality of modes for use for secure communication over a physical (PHY) channel, wherein each of the plurality of modes is associated with one or more of: one or more types of signals to secure using one or more secret keys; or one or more techniques to secure communication using the one or more secret keys.

The operations 800 may proceed to a third block 830, by communicating, with the UE, over the PHY channel in accordance with the mode.

In certain aspects, operations 800 may include transmitting, to the UE, a second indication of one of the plurality of corresponding techniques.

In certain aspects, operations 800 may include transmitting, to the UE, a message configuring the UE with the plurality of modes.

In certain aspects, operations 800 may include transmitting, to the UE, a message indicating a first set of resources for secure communication.

In certain aspects, operations 800 may include transmitting a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying a first entry of the TDRA table associated with a first bitmap indicating the first set of resources.

In certain aspects, operations 800 may include transmitting, to the UE, a key for decoding the message, wherein the message is encoded.

In certain aspects, each of the plurality of modes is associated with at least one technique of the one or more techniques, and the at least one technique comprises one or more of: use of noise based on the one or more secret keys; or use of modified quadrature amplitude modulation (QAM) points based on the one or more secret keys.

In certain aspects, each of the plurality of modes is associated with at least one type of signal of the one or more types of signals, and the one or more types of signals comprise one of: one or more demodulation reference signals; one or more control channels or data channels; or both the one or more demodulation reference signals and the one or more control channels or data channels.

In certain aspects, for a first mode of the plurality of modes, the one or more types of signals comprise one or more demodulation reference signals; for a second mode of the plurality of modes, the one or more types of signals comprise one or more control channels or data channels; and for a third mode of the plurality of modes, the one or more types of signals comprise both the one or more demodulation reference signals and the one or more control channels or data channels.

In certain aspects, the mode is associated with the one or more types of signals and a plurality of corresponding techniques to secure communication using the one or more secret keys.

In certain aspects, the message comprises one or more bitmaps, wherein each value of the one or more bitmaps indicates whether to secure communication for a particular resource.

In certain aspects, the first entry of the TDRA table is further associated with a second bitmap indicating a second set of resources, and wherein the DCI message identifies the first bitmap of the first entry.

In certain aspects, the one or more secret keys comprise a plurality of secret keys, and wherein, for the mode, different secret keys are used for different types of signals or different one or more resources.

### Example Wireless Communication Devices

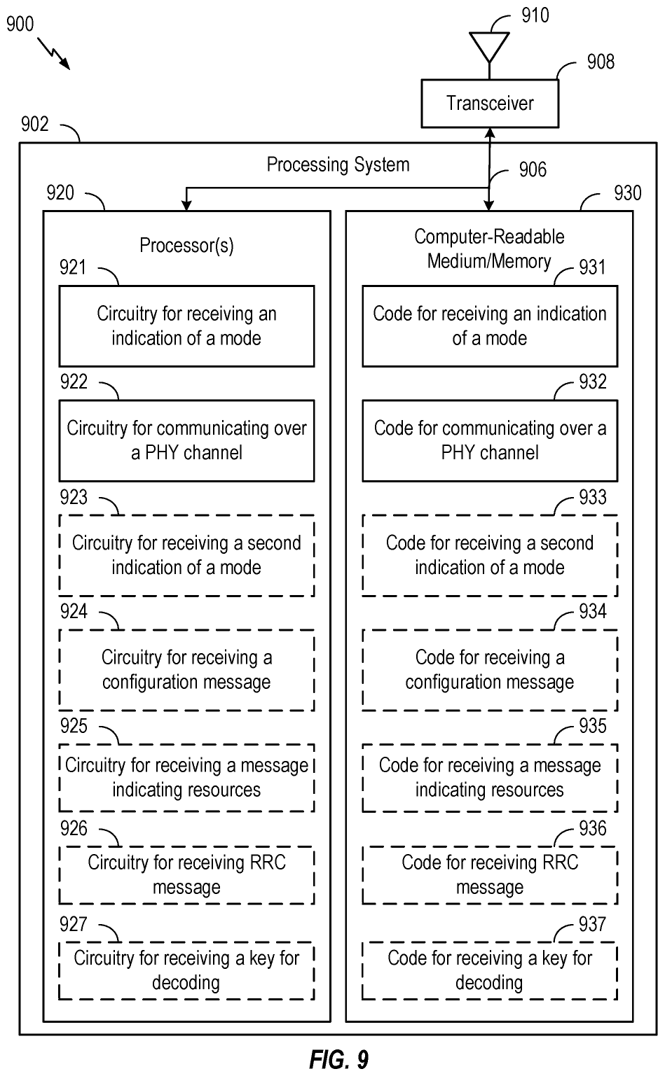

FIG. 9 depicts an example communications device 900 that includes various components operable, configured, or adapted to perform operations for the techniques disclosed herein, such as the operations depicted and described with respect to FIGS. 5-7. In some examples, communication device 900 may be a user equipment 104 as described, for example with respect to FIGS. 1, 2 and 3.

Communications device 900 includes a processing system 902 coupled to a transceiver 908 (e.g., a transmitter and/or a receiver). Transceiver 908 is configured to transmit (or send) and receive signals for the communications device 900 via an antenna 910, such as the various signals as described herein. Processing system 902 may be configured to perform processing functions for communications device 900, including processing signals received and/or to be transmitted by communications device 900.

Processing system 902 includes one or more processors 920 coupled to a computer-readable medium/memory 930 via a bus 906. In certain aspects, computer-readable medium/memory 930 is configured to store instructions (e.g., computer-executable code) that when executed by the one or more processors 920, cause the one or more processors 920 to perform the operations illustrated in FIGS. 5-7, or other operations for performing the various techniques discussed herein for securing physical layer communications.

In the depicted example, computer-readable medium/memory 930 stores code 931 for receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. Computer-readable medium/memory 930 may also store code 932 for communicating, with the wireless communication device, over the PHY channel in accordance with the mode.

Computer-readable medium/memory 930 may also store code 933 for receiving, from the wireless communication device, a second indication of one of the plurality of corresponding techniques, wherein the mode is associated with the one or more types of signals and a plurality of corresponding techniques to secure communication using the one or more secret keys, and wherein communication over the PHY channel is further in accordance with the one of the plurality of corresponding techniques.

Computer-readable medium/memory 930 may also store code 934 for receiving, from the wireless communication device, a message configuring the UE with the plurality of modes.

Computer-readable medium/memory 930 may also store code 935 for receiving, from the wireless communication device, a message indicating a first set of resources for secure communication, wherein communicating over the PHY channel in accordance with the mode comprises communicating over the PHY channel using the first set of resources.

Computer-readable medium/memory 930 may also store code 936 for receiving a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying first entry of the TDRA table associated with a first bitmap indicating the first set of resources.

Computer-readable medium/memory 930 may also store code 937 for receiving, from the wireless communication device, a key for decoding the message, wherein the message is encoded.

In the depicted example, the one or more processors 920 include circuitry configured to implement the code stored in the computer-readable medium/memory 930, including circuitry 921 for receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys. The one or more processors 920 may also include circuitry 922 for communicating, with the wireless communication device, over the PHY channel in accordance with the mode.

The one or more processors 920 may also include circuitry 923 for receiving, from the wireless communication device, a second indication of one of the plurality of corresponding techniques, wherein the mode is associated with the one or more types of signals and a plurality of corresponding techniques to secure communication using the one or more secret keys, and wherein communication over the PHY channel is further in accordance with the one of the plurality of corresponding techniques.

The one or more processors 920 may also include circuitry 924 for receiving, from the wireless communication device, a message configuring the UE with the plurality of modes.

The one or more processors 920 may also include circuitry 925 for receiving, from the wireless communication device, a message indicating a first set of resources for secure communication, wherein communicating over the PHY channel in accordance with the mode comprises communicating over the PHY channel using the first set of resources.

The one or more processors 920 may also include circuitry 926 for receiving a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying first entry of the TDRA table associated with a first bitmap indicating the first set of resources.

The one or more processors 920 may also include circuitry 927 for receiving, from the wireless communication device, a key for decoding the message, wherein the message is encoded.

Various components of communications device 900 may provide means for performing the methods described herein, including with respect to FIGS. 5-7.

In some examples, means for transmitting or sending (or means for outputting for transmission) may include the transceivers 354 and/or antenna(s) 352 of the user equipment 104 illustrated in FIG. 3 and/or transceiver 908 and antenna 910 of the communication device 900 in FIG. 9.

In some examples, means for receiving (or means for obtaining) may include the transceivers 354 and/or antenna(s) 352 of the user equipment 104 illustrated in FIG. 3 and/or transceiver 908 and antenna 910 of the communication device 900 in FIG. 9.

Notably, FIG. 9 is an example, and many other examples and configurations of communication device 900 are possible.

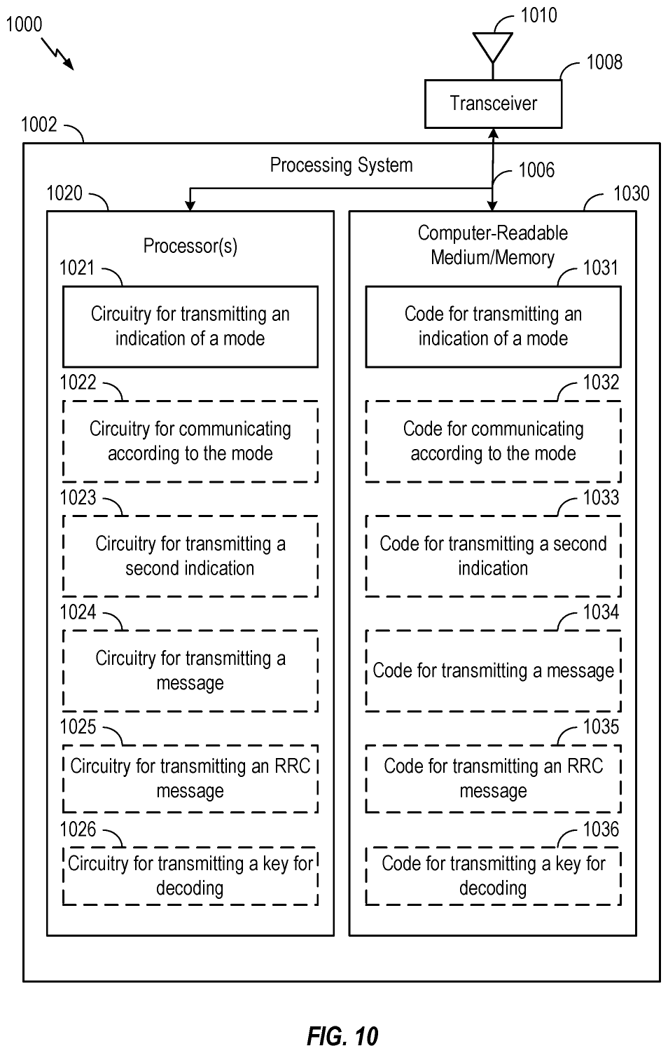

FIG. 10 depicts an example communications device 1000 that includes various components operable, configured, or adapted to perform operations for the techniques disclosed herein, such as the operations depicted and described with respect to FIGS. 5, 6, and 8. In some examples, communication device 1000 may be a base station 102 or a UE 104 as described, for example with respect to FIGS. 1, 2, and 3.

Communications device 1000 includes a processing system 1002 coupled to a transceiver 1008 (e.g., a transmitter and/or a receiver). Transceiver 1008 is configured to transmit (or send) and receive signals for the communications device 1000 via an antenna 1010, such as the various signals as described herein. Processing system 1002 may be configured to perform processing functions for communications device 1000, including processing signals received and/or to be transmitted by communications device 1000.

Processing system 1002 includes one or more processors 1020 coupled to a computer-readable medium/memory 1030 via a bus 1006. In certain aspects, computer-readable medium/memory 1030 is configured to store instructions (e.g., computer-executable code) that when executed by the one or more processors 1020, cause the one or more processors 1020 to perform the operations illustrated in FIGS. 5, 6, and 8, or other operations for performing the various techniques discussed herein for securing PHY layer communications.

In the depicted example, computer-readable medium/memory 1030 stores code 1031 for transmitting, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys.

The computer-readable medium/memory 1030 also stores code 1032 for communicating, with the UE, over the PHY channel in accordance with the mode.

The computer-readable medium/memory 1030 also stores code 1033 for transmitting, to the UE, a second indication of one of the plurality of corresponding techniques, wherein the mode is associated with the one or more types of signals and a plurality of corresponding techniques to secure communication using the one or more secret keys.

The computer-readable medium/memory 1030 also stores code 1034 for transmitting, to the UE, a message configuring the UE with the plurality of modes. In certain aspects, code 1034 is for transmitting, to the UE, a message indicating a first set of resources for secure communication.

The computer-readable medium/memory 1030 also stores code 1035 for transmitting a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying a first entry of the TDRA table associated with a first bitmap indicating the first set of resources.

The computer-readable medium/memory 1030 also stores code 1036 for transmitting, to the UE, a key for decoding the message, wherein the message is encoded.

In the illustrated example, the one or more processors 1020 include circuitry configured to implement the code stored in the computer-readable medium/memory 1030, including circuitry 1021 for transmitting, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys.

The one or more processors 1020 also include circuitry 1022 for communicating, with the UE, over the PHY channel in accordance with the mode.

The one or more processors 1020 also include circuitry 1023 for transmitting, to the UE, a second indication of one of the plurality of corresponding techniques, wherein the mode is associated with the one or more types of signals and a plurality of corresponding techniques to secure communication using the one or more secret keys.

The one or more processors 1020 also include circuitry 1024 for transmitting, to the UE, a message configuring the UE with the plurality of modes. Circuitry 1024 may also be for transmitting, to the UE, a message indicating a first set of resources for secure communication.

The one or more processors 1020 also include circuitry 1025 for transmitting a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying a first entry of the TDRA table associated with a first bitmap indicating the first set of resources.

The one or more processors 1020 also include circuitry 1026 for transmitting, to the UE, a key for decoding the message, wherein the message is encoded. Various components of communications device 1000 may provide means for performing the methods described herein, including with respect to FIGS. 5, 6, and 8.

In some examples, means for transmitting or sending (or means for outputting for transmission) may include the transceivers 332 and/or antenna(s) 334 of the base station 102 illustrated in FIG. 3 and/or transceiver 1008 and antenna 1010 of the communication device 1000 in FIG. 10. Alternatively, means for transmitting or sending (or means for outputting for transmission) may include the transceivers 354 and/or antenna(s) 352 of the user equipment 104 illustrated in FIG. 3.

In some examples, means for receiving (or means for obtaining) may include the transceivers 332 and/or antenna(s) 334 of the base station illustrated in FIG. 3 and/or transceiver 1008 and antenna 1010 of the communication device 1000 in FIG. 10. Alternatively, means for receiving (or means for obtaining) may include the transceivers 354 and/or antenna(s) 352 of the user equipment 104 illustrated in FIG. 3.

Notably, FIG. 10 is an example, and many other examples and configurations of communication device 1000 are possible.

### EXAMPLE CLAUSES

Implementation examples are described in the following numbered clauses:

Clause 1: A method for wireless communication by a user equipment (UE), the method comprising: receiving, from a wireless communication device, an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys; and communicating, with the wireless communication device, over the PHY channel in accordance with the mode.

Clause 2. The method of clause 1, wherein each of the plurality of modes is associated with at least one technique of the one or more techniques, and the at least one technique comprises one or more of: use of noise based on the one or more secret keys; or use of modified quadrature amplitude modulation (QAM) points based on the one or more secret keys.

Clause 3. The method of one or more of clauses 1 or 2, wherein each of the plurality of modes is associated with at least one type of signal of the one or more types of signals, and the one or more types of signals comprise one of: one or more demodulation reference signals; one or more control channels or data channels; or both the one or more demodulation reference signals and the one or more control channels or data channels.

Clause 4. The method of one or more of clauses 1-3, wherein: for a first mode of the plurality of modes, the one or more types of signals comprise one or more demodulation reference signals; for a second mode of the plurality of modes, the one or more types of signals comprise one or more control channels or data channels; and for a third mode of the plurality of modes, the one or more types of signals comprise both the one or more demodulation reference signals and the one or more control channels or data channels.

Clause 5. The method of one or more of clauses 1-4, wherein the communicating comprises one or more of: transmitting on a sidelink channel; receiving on the sidelink channel; transmitting on an uplink channel; or receiving on a downlink channel.

Clause 6. The method of one or more of clauses 1-5, wherein the mode is associated with the one or more types of signals and a plurality of corresponding techniques to secure communication using the one or more secret keys, wherein the method further comprises: receiving, from the wireless communication device, a second indication of one of the plurality of corresponding techniques, and wherein communication over the PHY channel is further in accordance with the one of the plurality of corresponding techniques.

Clause 7. The method of one or more of clauses 1-6, further comprising receiving, from the wireless communication device, a message configuring the UE with the plurality of modes.

Clause 8. The method of one or more of clauses 1-7, further comprising receiving, from the wireless communication device, a message indicating a first set of resources for secure communication, wherein communicating over the PHY channel in accordance with the mode comprises communicating over the PHY channel using the first set of resources.

Clause 9. The method of one or more of clauses 1-8, wherein the first set of resources comprises one or more of: a first set of time and frequency resources; or a first set of antenna ports of the UE.

Clause 10. The method of one or more of clauses 1-9, wherein the message comprises one or more bitmaps, wherein each value of the one or more bitmaps indicates whether to secure communication for a particular resource.

Clause 11. The method of one or more of clauses 1-10, further comprising receiving a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying a first entry of the TDRA table associated with a first bitmap indicating the first set of resources.

Clause 12. The method of one or more of clauses 1-11, wherein the first entry of the TDRA table is further associated with a second bitmap indicating a second set of resources, and wherein the DCI message identifies the first bitmap of the first entry.

Clause 13. The method of one or more of clauses 1-12, further comprising receiving, from the wireless communication device, a key for decoding the message, wherein the message is encoded.

Clause 14. The method of one or more of clauses 1-13, wherein the indication of the mode for secure communication comprises an indication of a quality of service (QoS), and wherein the method further comprises determining which of the plurality of modes for secure communication correspond to the QoS.

Clause 15. The method of one or more of clauses 1-14, wherein the one or more secret keys comprise a plurality of secret keys, and wherein, for the mode, different secret keys are used for different types of signals or different one or more resources.

Clause 16: An apparatus, comprising: a memory comprising executable instructions; one or more processors configured to execute the executable instructions and cause the apparatus to perform a method in accordance with any one of clauses 1-15.

Clause 17: An apparatus, comprising means for performing a method in accordance with any one of clauses 1-15.

Clause 18: A non-transitory computer-readable medium comprising executable instructions that, when executed by one or more processors of an apparatus, cause the apparatus to perform a method in accordance with any one of clauses 1-15.

Clause 19: A computer program product embodied on a computer-readable storage medium comprising code for performing a method in accordance with any one of clauses 1-15.

Clause 20. A method for wireless communication by a wireless communication device, the method comprising: transmitting, to a user equipment (UE), an indication of a mode of a plurality of modes for use for secure communication over a physical (PHY) channel, wherein each of the plurality of modes is associated with one or more of: one or more types of signals to secure using one or more secret keys; or one or more techniques to secure communication using the one or more secret keys; and communicating, with the UE, over the PHY channel in accordance with the mode.

Clause 21. The method of clause 20, wherein each of the plurality of modes is associated with at least one technique of the one or more techniques, and the at least one technique comprises one or more of: use of noise based on the one or more secret keys; or use of modified quadrature amplitude modulation (QAM) points based on the one or more secret keys.

Clause 22. The method of one or more of clauses 20 or 21, wherein each of the plurality of modes is associated with at least one type of signal of the one or more types of signals, and the one or more types of signals comprise one of: one or more demodulation reference signals; one or more control channels or data channels; or both the one or more demodulation reference signals and the one or more control channels or data channels.

Clause 23. The method of one or more of clauses 20-22, wherein: for a first mode of the plurality of modes, the one or more types of signals comprise one or more demodulation reference signals; for a second mode of the plurality of modes, the one or more types of signals comprise one or more control channels or data channels; and for a third mode of the plurality of modes, the one or more types of signals comprise both the one or more demodulation reference signals and the one or more control channels or data channels.

Clause 24. The method of one or more of clauses 20-23, wherein: the mode is associated with the one or more types of signals and a plurality of corresponding techniques to secure communication using the one or more secret keys; and the method further comprises: transmitting, to the UE, a second indication of one of the plurality of corresponding techniques.

Clause 25. The method of one or more of clauses 20-24, further comprising transmitting, to the UE, a message configuring the UE with the plurality of modes.

Clause 26. The method of one or more of clauses 20-25, further comprising transmitting, to the UE, a message indicating a first set of resources for secure communication.

Clause 27. The method of one or more of clauses 20-26, wherein the message comprises one or more bitmaps, wherein each value of the one or more bitmaps indicates whether to secure communication for a particular resource.

Clause 28. The method of one or more of clauses 20-27, further comprising transmitting a radio resource control (RRC) message comprising a time domain resource allocation (TDRA) table comprising a plurality of entries, wherein: each entry of the plurality of entries is associated with one or more bitmaps, each bitmap indicating a corresponding set of resources for secure communication; and the message comprises a downlink control information (DCI) message identifying a first entry of the TDRA table associated with a first bitmap indicating the first set of resources.

Clause 29. The method of one or more of clauses 20-28, wherein the first entry of the TDRA table is further associated with a second bitmap indicating a second set of resources, and wherein the DCI message identifies the first bitmap of the first entry.

Clause 30. The method of one or more of clauses 20-29, further comprising transmitting, to the UE, a key for decoding the message, wherein the message is encoded.

Clause 31. The method of one or more of clauses 20-30, wherein the one or more secret keys comprise a plurality of secret keys, and wherein, for the mode, different secret keys are used for different types of signals or different one or more resources.

Clause 32: An apparatus, comprising: a memory comprising executable instructions; one or more processors configured to execute the executable instructions and cause the apparatus to perform a method in accordance with any one of clauses 20-31.

Clause 33: An apparatus, comprising means for performing a method in accordance with any one of clauses 20-31.

Clause 34: A non-transitory computer-readable medium comprising executable instructions that, when executed by one or more processors of an apparatus, cause the apparatus to perform a method in accordance with any one of clauses 20-31.

Clause 35: A computer program product embodied on a computer-readable storage medium comprising code for performing a method in accordance with any one of clauses 20-31.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an SI interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mm Wave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 3, various example components of BS 102 and UE 104 (e.g., the wireless communication network 100 of FIG. 1) are depicted, which may be used to implement aspects of the present disclosure.

At BS 102, a transmit processor 320 may receive data from a data source 312 and control information from a controller/processor 340. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

At UE 104, antennas 352a-352r may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples (e.g., for OFDM) to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

On the uplink, at UE 104, transmit processor 364 may receive and process data (e.g., for the physical uplink shared channel (PUSCH)) from a data source 362 and control information (e.g., for the physical uplink control channel (PUCCH) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 4A-4D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 4A and 4C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A-4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 4B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 4C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of modes for securing PHY layer communications in wireless systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. CDMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). CDMA2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A user equipment (UE) configured for wireless communication, the UE comprising:
a memory; and
a processor coupled to the memory, the processor and the memory configured to:
receive, from a wireless communication device, an indication of a mode of a plurality of modes for use for secure communication over a physical (PHY) channel, wherein each of the plurality of modes is associated with one or more of:
one or more types of signals to secure using one or more secret keys; or
one or more techniques to secure communication using the one or more secret keys; and
communicate, with the wireless communication device, over the PHY channel in accordance with the mode.

2. The UE of claim 1, wherein each of the plurality of modes is associated with at least one technique of the one or more techniques, and the at least one technique comprises one or more of:
use of noise based on the one or more secret keys; or
use of modified quadrature amplitude modulation (QAM) points based on the one or more secret keys.

3. The UE of claim 1, wherein each of the plurality of modes is associated with at least one type of signal of the one or more types of signals, and the one or more types of signals comprise one of:
one or more demodulation reference signals;
one or more control channels or data channels; or
both the one or more demodulation reference signals and the one or more control channels or data channels.

4. The UE of claim 1, wherein:
for a first mode of the plurality of modes, the one or more types of signals comprise one or more demodulation reference signals;
for a second mode of the plurality of modes, the one or more types of signals comprise one or more control channels or data channels; and
for a third mode of the plurality of modes, the one or more types of signals comprise both the one or more demodulation reference signals and the one or more control channels or data channels.

5. The UE of claim 1, wherein the processor and the memory, being configured to communicate over the PHY channel in accordance with the mode, are further configured to one or more of:
transmit on a sidelink channel;
receive on the sidelink channel;
transmit on an uplink channel; or
receive on a downlink channel.

6. The UE of claim 1, wherein:
the mode is associated with the one or more types of signals and a plurality of corresponding techniques to secure communication using the one or more secret keys,
the processor and the memory are further configured to receive, from the wireless communication device, a second indication of one of the plurality of corresponding techniques,
communication over the PHY channel is further in accordance with the one of the plurality of corresponding techniques.

7. The UE of claim 1, wherein the processor and the memory are further configured to receive, from the wireless communication device, a message configuring the UE with the plurality of modes.

8. The UE of claim 1, wherein:
the processor and the memory are further configured to receive, from the wireless communication device, a message indicating a first set of resources for secure communication, and
the processor and the memory, being configured to communicate over the PHY channel in accordance with the mode, are further configured to communicate over the PHY channel using the first set of resources.

9. The UE of claim 8, wherein the first set of resources comprises one or more of:
a first set of time and frequency resources; or
a first set of antenna ports of the UE.

10. The UE of claim 8, wherein the message comprises one or more bitmaps, wherein each value of the one or more bitmaps indicates whether to secure communication for a particular resource.

11. The UE of claim 8, wherein the processor and the memory are further configured to receive a radio resource control (RRC) message comprising a time domain resource allocation (TDRA) table comprising a plurality of entries, and wherein:
each entry of the plurality of entries is associated with one or more bitmaps, each bitmap indicating a corresponding set of resources for secure communication; and
the message comprises a downlink control information (DCI) message identifying a first entry of the TDRA table associated with a first bitmap indicating the first set of resources.

12. The UE of claim 11, wherein the first entry of the TDRA table is further associated with a second bitmap indicating a second set of resources, and wherein the DCI message identifies the first bitmap of the first entry.

13. The UE of claim 8, wherein the processor and the memory are further configured to receive, from the wireless communication device, a key for decoding the message, wherein the message is encoded.

14. The UE of claim 1, wherein:
the indication of the mode for secure communication comprises an indication of a quality of service (QOS), and
the processor and the memory are further configured to determine which of the plurality of modes for secure communication correspond to the QoS.

15. The UE of claim 1, wherein the one or more secret keys comprise a plurality of secret keys, and wherein, for the mode, different secret keys are used for different types of signals or different one or more resources.

16. A wireless communication device, comprising:
a memory; and
a processor coupled to the memory, the processor and the memory configured to:
transmit, to a user equipment (UE), an indication of a mode of a plurality of modes for use for secure communication over a physical (PHY) channel, wherein each of the plurality of modes is associated with one or more of:
one or more types of signals to secure using one or more secret keys; or
one or more techniques to secure communication using the one or more secret keys; and
communicate, with the UE, over the PHY channel in accordance with the mode.

17. The wireless communication device of claim 16, wherein each of the plurality of modes is associated with at least one technique of the one or more techniques, and the at least one technique comprises one or more of:
use of noise based on the one or more secret keys; or
use of modified quadrature amplitude modulation (QAM) points based on the one or more secret keys.

18. The wireless communication device of claim 16, wherein each of the plurality of modes is associated with at least one type of signal of the one or more types of signals, and the one or more types of signals comprise one of:
one or more demodulation reference signals;
one or more control channels or data channels; or
both the one or more demodulation reference signals and the one or more control channels or data channels.

19. The wireless communication device of claim 16, wherein:
for a first mode of the plurality of modes, the one or more types of signals comprise one or more demodulation reference signals;
for a second mode of the plurality of modes, the one or more types of signals comprise one or more control channels or data channels; and
for a third mode of the plurality of modes, the one or more types of signals comprise both the one or more demodulation reference signals and the one or more control channels or data channels.

20. The wireless communication device of claim 16, wherein:
the mode is associated with the one or more types of signals and a plurality of corresponding techniques to secure communication using the one or more secret keys; and
the processor and the memory are further configured to transmit, to the UE, a second indication of one of the plurality of corresponding techniques.

21. The wireless communication device of claim 16, wherein the processor and the memory are further configured to transmit, to the UE, a message configuring the UE with the plurality of modes.

22. The wireless communication device of claim 16, wherein the processor and the memory are further configured to transmit, to the UE, a message indicating a first set of resources for secure communication.

23. The wireless communication device of claim 22, wherein the message comprises one or more bitmaps, wherein each value of the one or more bitmaps indicates whether to secure communication for a particular resource.

24. The wireless communication device of claim 22, wherein the processor and the memory are further configured to transmit a radio resource control (RRC) message comprising a time domain resource allocation (TDRA) table comprising a plurality of entries, wherein:
each entry of the plurality of entries is associated with one or more bitmaps, each bitmap indicating a corresponding set of resources for secure communication; and
the message comprises a downlink control information (DCI) message identifying a first entry of the TDRA table associated with a first bitmap indicating the first set of resources.

25. The wireless communication device of claim 24, wherein the first entry of the TDRA table is further associated with a second bitmap indicating a second set of resources, and wherein the DCI message identifies the first bitmap of the first entry.

26. The wireless communication device of claim 22, wherein the processor and the memory are further configured to transmit, to the UE, a key for decoding the message, wherein the message is encoded.

27. The wireless communication device of claim 16, wherein the one or more secret keys comprise a plurality of secret keys, and wherein, for the mode, different secret keys are used for different types of signals or different one or more resources.

28. A method for wireless communication by a user equipment (UE), the method comprising:
receiving, from a wireless communication device, an indication of a mode of a plurality of modes for use for secure communication over a physical (PHY) channel, wherein each of the plurality of modes is associated with one or more of:
one or more types of signals to secure using one or more secret keys; or
one or more techniques to secure communication using the one or more secret keys; and
communicating, with the wireless communication device, over the PHY channel in accordance with the mode.

29. The method of claim 28, wherein each of the plurality of modes is associated with at least one technique of the one or more techniques, and the at least one technique comprises one or more of:
use of noise based on the one or more secret keys; or
use of modified quadrature amplitude modulation (QAM) points based on the one or more secret keys.

30. A method for wireless communication by a wireless communication device, the method comprising:
transmitting, to a user equipment (UE), an indication of a mode of a plurality of modes for use for secure communication over a physical (PHY) channel, wherein each of the plurality of modes is associated with one or more of:
one or more types of signals to secure using one or more secret keys; or
one or more techniques to secure communication using the one or more secret keys; and
communicating, with the UE, over the PHY channel in accordance with the mode.
